(19) United States
(12) Patent Application Publication
(10) Pub. No.: US 2007/0281719 A1
(43) Pub. Date: Dec. 6, 2007

(54) METHOD FOR DIRECT MARKETING TO MOBILE COMMUNICATION DEVICES

(76) Inventors: Christoffer Bylock, Stockholm (SE); Viktor Eriksson, Nacka (SE); Mathias Teljstedt, Nacka (SE); Marko Holappa, Lidingo (SE)

Correspondence Address: FASTH LAW OFFICES (ROLF FASTH), 26 PINECREST PLAZA, SUITE 2, SOUTHERN PINES, NC, 28387-4301, US

(21) Appl. No.: 11/754,679

(22) Filed: May 29, 2007

Related U.S. Application Data
(60) Provisional application No. 60/803,687, filed on Jun. 1, 2006.

(51) Int. Cl. H04Q 7/20

(52) U.S. Cl. 455/466

(57) ABSTRACT

The method relates to a method for direct marketing to mobile communication devices, such as mobile telephones, while the sender can send free text messages to a receiver who receives both the text message and a commercial message. The commercial message is selected based on the location of the receiver, the user profile of the receiver or the time of the day so that the commercial message is in conformance with sponsor criteria.

### PRIOR APPLICATION

This U.S. patent application claims priority from U.S. provisional patent application No. 60/803,687, filed 1 Jun. 2006.

### TECHNICAL FIELD

The method relates to a method for direct marketing to mobile communication devices, such as mobile telephones, while the sender can send free text messages to a receiver who receives both the text message and a commercial message.

### BACKGROUND OF INVENTION

Commercial messages are commonly used in a wide variety of mass media such as newspapers and television. Such commercial messages and advertising are not very focused and are often not particularly effective for reaching specific target groups. Similarly, commercial messages, such as spam, sent by electronic mail also lack focus and often do not reach the right target groups. Another problem is that it is quite expensive for users to send text messages to mobile telephones. This is a particular problem for young users with very limited resources.

There is a need for a more effective way of providing commercial messages that takes advantage of the currently available technology to better focus commercial messages on target groups and specific users. There is also a need for providing a communication service that is affordable to the users.

### SUMMARY OF INVENTION

The method of the present invention provides a solution to the above-outlined problems. More particularly, the method is for direct marketing to mobile communication devices. A first mobile communication device is, via an operator, in communication with a second mobile communication device. The first device sends an electronic text message. A server of the operator receives the text message. The server determines whether a sender is a member of a service. The server sends a message, including the text message, to a web server when the sender is a member. The web server receives the message and may select a commercial message based on a current location, time of the day or user profile of the second device. The web server integrates the text message, created by the sender, with the commercial message to form a multimedia message. The operator receives the multimedia message and forwards the multimedia message, free of charge or subsidized to the sender, to the second device. The second device simultaneously displays the text message and the commercial message on the second device.

### BRIEF DESCRIPTION OF DRAWINGS

FIG. 1 is a schematic view of an information flow of the system of the present invention; and

FIG. 2 is an example of a message on a mobile telephone that includes a commercial message together with a text message.

### DETAILED DESCRIPTION

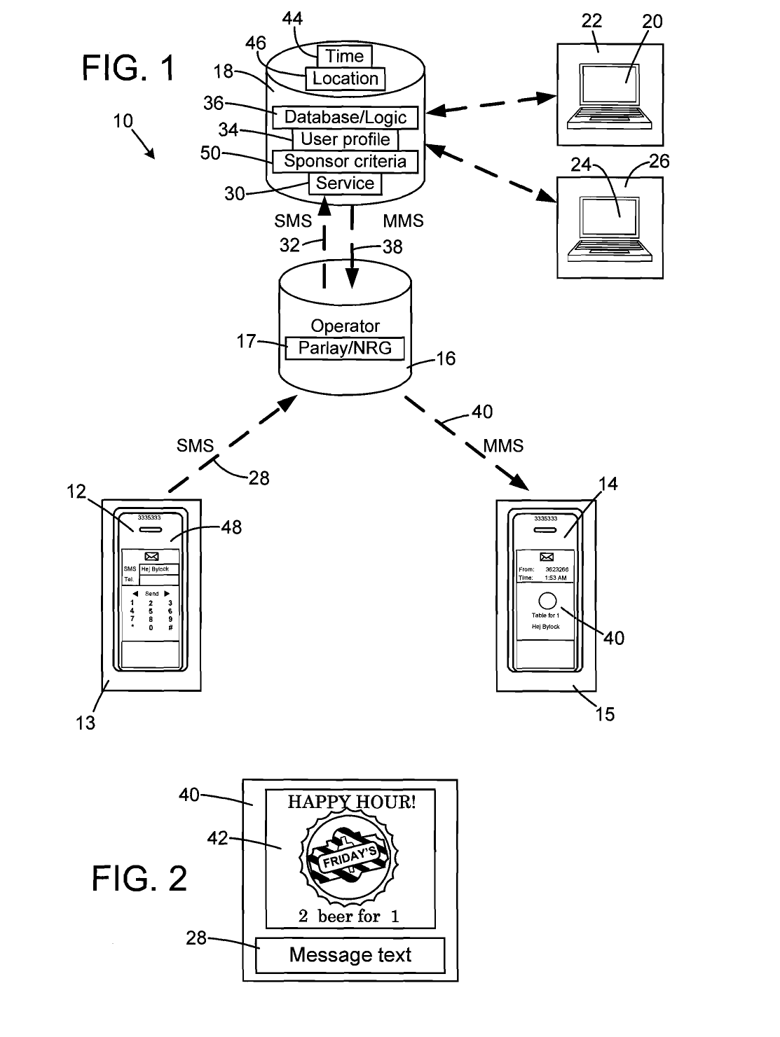

With reference to FIGS. 1-2, the system 10 of the present invention relates to a method for direct marketing to mobile communication devices, such as mobile telephones, while enabling the sender to send free text messages to a receiver who receives both the text message and a commercial message. This means there is no charge to the sender or the receiver. The commercial messages are sponsored by sponsoring companies that may select target groups based on such criteria as user profile, position and time of the day when the message is sent. In this way, the commercial messages are integrated with the everyday SMS communications between senders and users.

More particularly, the system 10 has a first or sending mobile communication device 12, such as a mobile telephone, that is in communication with a second or receiving mobile communication device 14, such as a mobile telephone, via a suitable server 17 of a telephone operator 16. A web server 18 is also in communication with the operator 16. A website 20 of a service provider 22 and a website 24 of a sponsoring company 26 are also in communication with the server 18 such as via the Internet.

The sending device 12 may create and send an electronic text message 28, such as an SMS, that is received by the operator 16. The message 28 has, in addition to the message itself, information about the sending device 12 and the receiving device 14 such as telephone numbers and geographical location. The operator 16 may also determine the location of the receiving device 14 based on the telephone number to the receiving device 14.

The operator 16 determines whether the user/sender 13 of the sending device 12 is a registered user of a free text message service 30 provided by the service provider 22. For example, the operator 16 may determine that the sender is a member of the service 30 since the telephone number 48 of the sending device 12 is listed as being a member of the service 30. If so the message 28 may be sent for free but is first routed in a forwarding signal 32 to the web server 18.

If the user is not a member of the service 30, the user/sender 13 may register by visiting the website 20 or by visiting a suitable store to provide obtain registration by user profile information 34 of the user 13 that relates to age, sex, consumption habits, interests etc. of the sender 13.

The server 18 receives the signal 32. The server 18 may request geographical location information of the receiving device 14 from the operator 16 if this information is not already included in the signal 32. The server 18 may then search for a suitable commercial message 42 in a database 36 that, among other things, stores available commercial messages and user profile information of the user/sender 13 and the receiver 15 if both are members of the service 30. One important feature of the present invention is that the commercial message is adjusted to the receiver 15 and, preferably, is based on a location 46, the user profile 34 and time 44 the message is sent to the receiver 15. For example, the time 44 may include time periods during the day when the sponsoring company wants to market its products/services by sending commercial messages. As an example, a sponsoring lunch restaurant may only want commercial messages to be sent to suitable receivers between 11 am to about 2 pm and only to receivers that are within a certain radius, such as 1 kilometer, from the lunch restaurant of the sponsoring company.

Thus, the commercial message selected must fit the sponsor criteria 50 that sponsoring companies may have specified for the target groups of the companies' marketing campaign. In this way, the commercial message can be made very focused to the user and may include commercial messages that, for example, relates to lunch restaurants when the sponsoring company is a lunch restaurant and the message is sent around lunchtime. The message may also be adjusted to include a restaurant that is close to the receiver 15 at the time the message is sent. Finally, the message may of course be adjusted to the specific needs of the receiver as determined by the user profile information.

In general, the server 18 converts the signal 32 from an SMS format to an MMS format or any other suitable format that may include commercial messages together with the text message from the sender, so that pictures and other commercial messages can be included. The server 18 then sends back a return message 38 to the operator 16 that forwards the message to the device 14 as a message 40 in the MMS format. The sponsoring company 26 may be invoiced by the service provider 22 based on the number of MMS signals, that include commercial messages from the sponsoring company, that are sent to receivers.

As best shown in FIG. 2, the device 14 of the receiver 15 receives the message 40 that includes both a commercial message 42 and the message 28 from the sender 13.

Even if the receiver 15 is not a registered user of the system 10, it is still possible to adapt the commercial message to the receiver 15. For example, the telephone number may be linked to an address so that there is a good likelihood that the receiver is close to that address and commercial messages from companies close to that address may be used. It may also be possible to link the telephone number to a social security number so that other information may be obtained or bought from external databases such as information related to car ownership, age, gender, interests, golf club membership and income. The commercial message sent to the receiver may thus be adjusted to the above information.

The system may also make educated guesses about the receiver based on known information about the sender. For example, the system 10 could assume that they both are about the same age particularly if the sender is very young such as a teenager who is sending SMS to the sender's friends. In that case, the receiver may also be a good candidate for commercial messages that are similar to those that are suitable for the sender.

It may also be possible to make educated guesses based on the location of the sender and the receiver. For example, if the receiver has a current address in a city and the sender is currently located in the same city, there is a high likelihood that the receiver is located in the same city also particularly if the frequency of the SMS is high so that the system may be used to map the behavior of the sender and receiver. The system 10 may also save information to improve the educated guesses.

One way of selecting which commercial message is to be sent when there are conflicting criteria is to give high paying sponsoring companies a higher priority than low paying sponsoring companies.

While the present invention has been described in accordance with preferred compositions and embodiments, it is to be understood that certain substitutions and alterations may be made thereto without departing from the spirit and scope of the following claims.

1. A method for direct marketing to mobile communication devices, comprising:
providing a first mobile communication device in communication with a second mobile communication device via an operator;
the first device sending an electronic text message;
a server of the operator receiving the text message;
the server determining whether a sender is a member of a service;
the server sending a message, including the text message, to a web server when the sender is a member;
the web server receiving the message and identifying a commercial message based on a current location of the second device;
the web server integrating the text message, created by the sender, with the commercial message to form a multimedia message;
the operator receiving the multimedia message and forwarding a multimedia message, free of charge to the sender, to the second device; and
the second device simultaneously displaying the text message and the commercial message on the second device.

2. The method according to claim 1 wherein the method further comprises selecting the commercial message based on a time.

3. The method according to claim 2 wherein the method further comprises selecting the commercial message based on a user profile.

4. The method according to claim 3 wherein the method further comprises selecting the commercial message based on sponsor criteria.

5. The method according to claim 1 wherein the method further comprises conducting a search in external databases for user profile information of a receiver when the receiver is not a member of the service of a service provider.

6. The method according to claim 5 wherein the method further comprises the system carrying educated guesses about the user profile of the receiver based on the user profile of the sender.

7. The method according to claim 1 wherein the method further comprises the server determines a membership status of the sender based on a telephone number of the first device.

8. The method according to claim 1 wherein the method further comprises charging a sponsoring company based on a number of messages, that include commercial messages, that are sent to receivers.

9. The method according to claim 1 wherein the method further comprises providing the multimedia message free of charge to the receiver.
